(19) United States
(12) Patent Application Publication
(10) Pub. No.: US 2025/0374165 A1
(43) Pub. Date: Dec. 4, 2025

(54) UNMANNED WIRELESS RELAY MOBILE UNIT AND WIRELESS BASE STATION

(71) Applicant: JVCKENWOOD Corporation, Yokohama-shi (JP)

(72) Inventor: Tadasuke Okutomi, Yokohama-shi (JP)

(21) Appl. No.: 19/299,404

(22) Filed: Aug. 14, 2025

Related U.S. Application Data
(63) Continuation of application No. PCT/JP2024/007740, filed on Mar. 1, 2024.

(30) Foreign Application Priority Data
Mar. 17, 2023 (JP) 2023-043386

(51) Int. Cl. H04W 40/22; H04W 16/26; H04W 24/04; H04W 24/08

(52) U.S. Cl. CPC H04W 40/22; H04W 16/26; H04W 24/04; H04W 24/08

(57) ABSTRACT

The number of unmanned wireless relay mobile units in operation is adjusted to an appropriate number according to a usage status. A communication unit that relays a wireless signal, a signal intensity measurement unit that measures a signal intensity value, and a request unit that communicates, by means of the communication unit, a request signal to request addition or elimination of an unmanned wireless relay mobile unit, to a wireless base station are included. In a case where an unmanned wireless relay mobile unit is in direct communication with the wireless base station, its request unit transmits a request signal to request addition of another unmanned wireless relay mobile unit when a base station signal intensity value is smaller than a first threshold or when a relay signal intensity value for a relay destination is smaller than a third threshold.

### CROSS-REFERENCE TO RELATED APPLICATIONS

This application is a Continuation of PCT International Application No. PCT/JP2024/007740 filed on Mar. 1, 2024 which claims the benefit of priority from Japanese Patent Application No. 2023-043386, filed on Mar. 17, 2023, the entire contents of both of which are incorporated herein by reference.

### BACKGROUND OF THE INVENTION

### 1. Field of the Invention

The present invention relates to unmanned wireless relay mobile units and wireless base stations.

### 2. Description of the Related Art

Unmanned wireless relay mobile units, such as robots, which relay wireless communication with wireless base stations, have been known (for example, see Japanese Patent No. 3229476).

According to a technique disclosed in Japanese Patent No. 3229476, in moving a robot within range, the robot having been connected to plural relay stations on a base station side, while performing wireless communication between the robot and the base station, if the received intensity of radio waves transmitted to the robot becomes lower than a predetermined value, a relay station on the base station side is disconnected, the relay station having been connected at that point, and radio waves transmitted from the base station are relayed by that disconnected relay station and transmitted to the robot.

However, because relay stations are successively disconnected while the robot moves, the technique disclosed in Japanese Patent No. 3229476 is limited to expanding the range of relay of wireless signals (increasing relay points). Therefore, the technique disclosed in Japanese Patent No. 3229476 does not enable reduction of the range of relay according to the usage status of wireless communication, too many relay stations need to be prepared for the wireless communication range, and even if some of the relay stations become unnecessary due to a change in the communication status, the unnecessary relay stations need to be kept in operation. Therefore, the number of unmanned wireless relay mobile units in operation is desirably able to be adjusted to an appropriate number according to the usage status.

### SUMMARY OF THE INVENTION

It is an object of the present invention to at least partially solve the problems in the conventional technology.

The above and other objects, features, advantages and technical and industrial significance of this invention will be better understood by reading the following detailed description of presently preferred embodiments of the invention, when considered in connection with the accompanying drawings.

An unmanned wireless relay mobile unit according to the present disclosure, comprising: a communication unit that relays a wireless signal; a signal intensity measurement unit that measures a signal intensity value of a wireless signal received by the communication unit; and a request unit that communicates, by means of the communication unit, a request signal to request addition or elimination of an unmanned wireless relay mobile unit, to a wireless base station, on the basis of the signal intensity value, wherein the signal intensity measurement unit measures a base station signal intensity value of a signal received by the communication unit from the wireless base station and a relay signal intensity value of a signal received from another unmanned wireless relay mobile unit in operation, and in a case where the unmanned wireless relay mobile unit is in direct communication with the wireless base station, the request unit transmits the request signal to request addition of another unmanned wireless relay mobile unit when the base station signal intensity value is smaller than a first threshold or when the relay signal intensity value for a relay destination is smaller than a third threshold.

A wireless base station that communicates with an unmanned wireless relay mobile unit that according to the present disclosure comprises: a communication unit that relays a wireless signal; a signal intensity measurement unit that measures a signal intensity value of a wireless signal received by the communication unit; and a request unit that transmits a request signal to request addition or elimination of an unmanned wireless relay mobile unit to the wireless base station on the basis of the signal intensity value, the wireless base station comprising: a base station communication unit that transmits and receives wireless signals; and an instruction unit that determines, in a case where the base station communication unit has received the request signal to request addition of a new unmanned wireless relay mobile unit from the unmanned wireless relay mobile unit, an additional point for the new unmanned wireless relay mobile unit and outputs an instruction to the new unmanned wireless relay mobile unit for the new unmanned wireless relay mobile unit to be placed at the additional point, wherein the instruction unit periodically transmits presence confirmation signals to unmanned wireless relay mobile units in operation and in a case where the instruction unit has not acquired a response signal from any of the unmanned wireless relay mobile units in operation over a predetermined time period, the instruction unit determines an additional point for a new unmanned wireless relay mobile unit and outputs an instruction to this new unmanned wireless relay mobile unit for the new unmanned wireless relay mobile unit to be placed at the additional point.

### BRIEF DESCRIPTION OF THE DRAWINGS

FIG. 1 is a block diagram illustrating a communication system including a wireless relay drone according to a first embodiment;

FIG. 2 is a schematic diagram illustrating an example of a wireless communication area constructed by wireless relay drones and a wireless base station;

FIG. 3 is a diagram for description of a method of determining an additional point for a wireless relay drone;

FIG. 4 is a flowchart illustrating a drone increase or decrease determination process;

FIG. 5 is a diagram illustrating a first exemplary case of a request for addition of a wireless relay drone;

FIG. 6 is a diagram illustrating a second exemplary case of the request for addition of a wireless relay drone;

FIG. 7 is a diagram illustrating an exemplary case of a request for elimination of wireless relay drones;

FIG. 8 is a sequence diagram illustrating a flow of operation in a communication system; and

FIG. 9 is a sequence diagram illustrating a flow of operation in a communication system according to a second embodiment.

### DETAILED DESCRIPTION OF THE PREFERRED EMBODIMENTS

Unmanned wireless relay mobile units and wireless base stations, according to embodiments of the present invention will be described in detail by reference to the appended drawings. The present invention is not to be limited by the following embodiments.

### First Embodiment

### Outline of Communication System

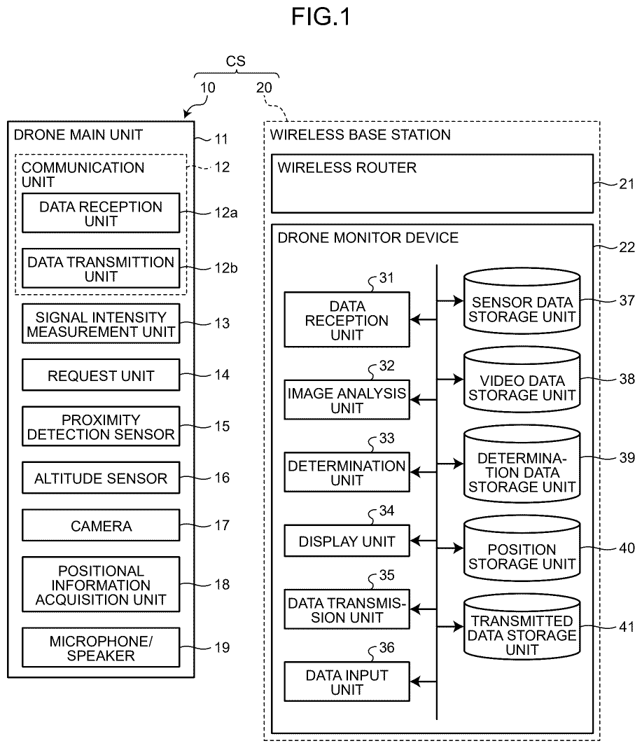

FIG. 1 is a block diagram illustrating a communication system CS according to a first embodiment. A wireless relay drone (unmanned wireless relay mobile unit) 10 and a wireless base station 20, according to the first embodiment, are included in the communication system CS that constructs a wireless communication area where wireless communication by a wireless communication terminal is possible, for example.

The communication system CS is used for the purpose of temporarily constructing a wireless communication area in a place where no wireless communication area has been constructed, for, for example, work to be carried out in that place. In this case, the communication system CS constructs a wireless communication area having a limited range by placing a wireless base station 20 in a place where a wireless communication area is desired to be constructed. However, due to the installation environment and the kind of work, sufficient signal intensity is not necessarily obtained at all positions in the wireless communication area. In a case where there is a location where the signal intensity is low or a local communication failure occurs in the wireless communication area, for example, the communication system CS thus enables sufficient signal intensity to be obtained at a location needed by placing one or more wireless relay drones 10. Configurations of the wireless relay drone 10 and the wireless base station 20 will be described first.

### Configuration of Wireless Relay Drone (Unmanned Wireless Relay Mobile Unit)

As illustrated in FIG. 1, the wireless relay drone (unmanned wireless relay mobile unit) 10 includes a drone main unit (mobile main unit) 11 including a communication unit 12, a signal intensity measurement unit 13, and a request unit 14.

The drone main unit 11 is an unmanned aerial vehicle. The drone main unit 11 is capable of moving by flying through the air and holding its position in the air (hovering). The drone main unit 11 is a device that places a wireless relay device (the communication unit 12) at a relay point by flying.

The communication unit 12 relays a wireless signal. That is, the communication unit 12 is capable of receiving a wireless signal from another wireless communication device (for example, the wireless base station 20, another wireless relay drone 10, or a wireless communication terminal) and transmitting the wireless signal received. The communication unit 12 has a data reception unit 12a and a data transmission unit 12b each including a wireless communication module. In addition to a function of relaying, the data reception unit 12a has a function of receiving an instruction to its vehicle from the wireless base station 20 and the data transmission unit 12b has a function of wirelessly transmitting various data that its vehicle has acquired to the wireless base station 20.

The signal intensity measurement unit 13 measures a signal intensity value of a wireless signal received by the communication unit 12.

The request unit 14 has a function of communicating, on the basis of a signal intensity value, a request signal to request addition or elimination of a wireless relay drone 10, to the wireless base station 20. The request unit 14 transmits the request signal by means of the communication unit 12. The request unit 14 includes, for example, a computation circuit, such as a central processing unit (CPU), and a memory. The memory is, for example, a nonvolatile semiconductor storage device, such as a flash memory.

The drone main unit 11 further includes a proximity detection sensor 15, an altitude sensor 16, a camera 17, a positional information acquisition unit 18, and a microphone/speaker 19. The proximity detection sensor 15 detects a distance to an object that would be an obstacle when the drone main unit 11 flies. The altitude sensor 16 detects altitude of the drone main unit 11. The camera 17 captures an image of a status of a relay point. The positional information acquisition unit 18 acquires positional information on the drone main unit 11. The positional information acquisition unit 18 acquirers the positional information by using a positioning system, such as a global positioning system (GPS), for example. The microphone/speaker 19 collects sound at a relay point and generates an alarm sound as needed.

### Wireless Base Station

The wireless base station 20 includes a wireless router (base station communication unit) 21 and a drone monitor device (instruction unit) 22.

The wireless router 21 transmits and receives wireless signals. The wireless router 21 is a wireless device that connects plural wireless communication devices to one another or connects a wireless communication terminal to another network. The wireless router 21 uses the wireless relay drone 10 as a relay device.

The scheme of communication by the wireless router 21 is not particularly limited. The scheme of communication is, for example, of wireless LAN communication compliant with the Institute of Electrical and Electronics Engineers (IEEE) 802.11 standard. The scheme of communication may be, for example, of local 5G.

The drone monitor device 22 monitors the state of any wireless relay drone 10 in operation by communicating with that wireless relay drone 10 via the wireless router 21. The drone monitor device 22 has a function of providing an instruction to cause a wireless relay drone 10 on standby to move to a relay point and to execute a relay process and an instruction to a wireless relay drone 10 in operation for the wireless relay drone 10 in operation to return to a standby location.

In the first embodiment, in a case where the wireless router 21 has received a request signal, the drone monitor device 22 determines an additional point for a new wireless relay drone 10 and provides an instruction to the new wireless relay drone 10 for the new wireless relay drone 10 to be placed at the additional point.

The drone monitor device 22 includes a data reception unit 31, an image analysis unit 32, a determination unit 33, a display unit 34, a data transmission unit 35, a data input unit 36, a sensor data storage unit 37, a video data storage unit 38, a determination data storage unit 39, a position storage unit 40, and a transmitted data storage unit 41.

The data reception unit 31 receives various data from wireless relay drones 10 via the wireless router 21. The data reception unit 31 stores the data received, to the corresponding storage units. The data reception unit 31 includes a wireless communication module. Drone IDs (identifiers) are assigned to wireless relay drones 10 in operation and the various data are stored to be distinguishable by the drone IDs of the transmission sources or reception destinations of the data.

On the basis of a distance from the wireless base station 20 to a wireless relay drone 10 and a signal intensity, the determination unit 33 determines a failure level (severity of a communication failure). Details of this determination will be described later. The determination unit 33 includes, for example, a computation circuit, such as a central processing unit (CPU).

The display unit 34 displays a state of each wireless relay drone 10, received data, and a failure level determination result. The display unit 34 includes a liquid crystal display device, for example. The data transmission unit 35 includes a wireless communication module and transmits various instructions to wireless relay drones 10 via the wireless router 21. For example, the data transmission unit 35 is capable of transmitting an instruction for movement to a relay point to start relay, a response instruction corresponding to a failure level, or a return instruction, to a wireless relay drone 10. The data input unit 36 receives input of operation for specification of a position of a relay point or a drone return instruction for ending the work. The data input unit 36 includes an input device, such as a keyboard, a mouse, and/or a touch panel.

The sensor data storage unit 37 stores respective sensor data. The video data storage unit 38 stores video data. The determination data storage unit 39 stores a failure level determination result. The position storage unit 40 stores positional information on a wireless relay drone 10. The transmitted data storage unit 41 stores data transmitted to the drone main unit 11. These sensor data storage unit 37, video data storage unit 38, determination data storage unit 39, position storage unit 40, and transmitted data storage unit 41 are, for example, nonvolatile storage devices, such as hard disk drives (HDDs) and/or solid state drives (SSDs).

### Specific Example of Construction of Wireless Communication Area

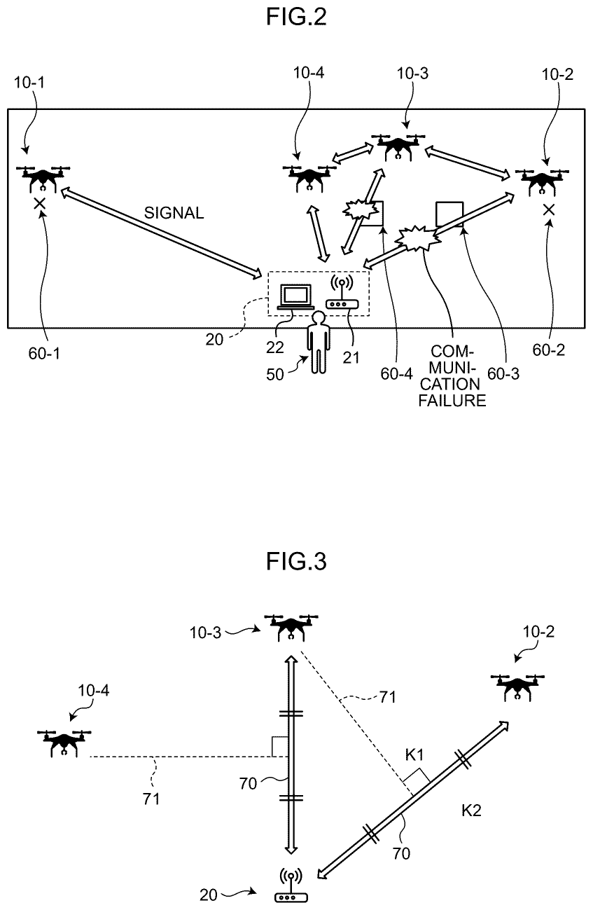

FIG. 2 is an example where a wireless communication area is constructed by wireless relay drones 10 and the wireless base station 20.

FIG. 2 is an example where a place that the wireless communication area is constructed in is indoor, the place being in, for example, a factory where machinery is installed. In a case where work, such as construction, is carried out in the factory, for example, the communication system CS provisionally constructs (temporarily provides) a wireless communication area to be used for the work in the factory. Areas (failure areas) are generated in the factory, the areas being where wireless communication is reduced in signal intensity due to noise generated from the machinery and mechanical equipment and materials (obstructions) carried in for the work. It is assumed herein that such failure areas are randomly generated in the factory. Initial installation of the wireless router 21 and operation of the drone monitor device 22 are carried out by an operator 50, at the wireless base station 20.

In a case where a wireless relay drone 10 is to be placed, the drone monitor device 22 is operated by the operator 50 and a relay point is specified to the communication system CS, first. For example, a point 60-1 or a point 60-2 in FIG. 2 is specified as a relay point.

A wireless relay drone 10 flies to an area near a relay point that has been specified and measures a base station signal intensity value for the wireless base station 20.

Relay of wireless signals performed by a wireless relay drone 10 includes communication between that wireless relay drone 10 and the wireless base station 20 and communication between the wireless relay drone 10 and another wireless relay drone 10. Therefore, its signal intensity measurement unit 13 measures a base station signal intensity value of a signal that its communication unit 12 has received from the wireless base station 20 and a relay signal intensity value of a signal received from another wireless relay drone 10 that is in operation.

Specifically, the signal intensity measurement unit 13 finds a base station signal intensity value by measuring signal intensities of presence confirmation signals periodically received from the wireless base station 20. Furthermore, the signal intensity measurement unit 13 finds a relay signal intensity value by periodically transmitting signals to another wireless relay drone 10 at a relay destination and measuring response signals received therefrom.

A wireless relay drone 10 transmits various measurement results including a base station signal intensity value, a relay signal intensity value, and positional information, to the wireless base station 20. On the basis of the information received, the drone monitor device 22 of the wireless base station 20 determines a failure level according to Table 1 below.

TABLE 1

| | Distance from | Distance from | Distance from |
|---|---|---|---|
| Signal intensity | base station: | base station: | base station: |
| value | near | medium | far |
| 4 | Failure level 0 | Failure level 0 | Failure level 0 |
| 3 | Failure level 2 | Failure level 1 | Failure level 1 |
| 2 | Failure level 3 | Failure level 3 | Failure level 3 |
| 1 | Failure level 4 | Failure level 4 | Failure level 4 |
| None | Failure level 5 | Failure level 5 | Failure level 5 |

As listed in Table 1, in the first embodiment, signal intensity values (base station signal intensity values and relay signal intensity values) are categorized into five levels, ‘1 to 4’ and ‘none’, and a higher numerical value indicates a higher signal intensity. “None” indicates that no wireless signal was able to be received. In a case where the wireless base station 20 has been unable to receive various kinds of information periodically transmitted from a wireless relay drone 10 over a predetermined time period or more, the signal intensity value is categorized as “none” exceptionally. Furthermore, on the basis of positional information received, the drone monitor device 22 categories distances from the wireless base station 20 to wireless relay drones 10 to be subjected to determination, into three levels, “near”, “medium”, and “far”. The determination of failure levels in Table 1 may be reviewed during operation to be modified to more suitable determination.

The failure levels are categorized into six levels, “0 to 5”. The drone monitor device 22 transmits response instructions corresponding to failure level determination results to wireless relay drones 10.

As listed in Table 2 below, wireless relay drones 10 are configured to operate in drone modes corresponding to failure levels that they have received. As described later, in a drone increase or decrease determination process executed in operation of each drone mode, a wireless relay drone 10 determines, on the basis of a signal intensity value, whether or not a request for addition or elimination of another wireless relay drone 10 is to be made.

TABLE 2

| Failure level | Drone mode determined |
|---|---|
| 0 | Standby mode |
| 1 and 2 | Single unit response mode |
| 3 | Cooperative response mode |
| 4 | Second cooperative response mode |
| 5 | Abnormality detection mode |

In a case where the failure level is “0”, the wireless relay drone 10 operates in a standby mode. The standby mode is a mode where no special response is made because no communication failure has occurred and wireless relay is continued at the relay point.

In a case where the failure level is “1” or “2”, the wireless relay drone 10 operates in a single unit response mode. In this single unit response mode, the wireless relay drone 10 attempts to improve the signal intensity by moving by predetermined distances in respective directions. In this attempt, the wireless relay drone 10 (signal intensity measurement unit 13) respectively acquires signal intensity values at plural locations in a predetermined range including the relay point for wireless signals. The wireless relay drone 10 (request unit 14) specifies a direction of a failure area where a communication failure has occurred, from differences among the signal intensity values at the plural locations.

In a case where the failure level is “3”, the wireless relay drone 10 operates in a cooperative response mode. In the cooperative response mode, as a result of a drone increase or decrease determination process described later, a request signal for addition of a drone is transmitted from the request unit 14 of the wireless relay drone 10 that is in operation. In a case where the request unit 14 transmits a request signal to request addition of a wireless relay drone 10, the request unit 14 transmits the direction of the failure area where the communication failure has occurred, to the wireless base station 20.

On the basis of the request signal for the addition and the direction of the failure area, the drone monitor device 22 determines an additional point and instructs an additional wireless relay drone 10 to move to the additional point. The wireless relay drone 10 that has been added is also configured to transmit various measurement results including a base station signal intensity value, a relay signal intensity value, and positional information, to the wireless base station 20 and to operate in a drone mode corresponding to a failure level received.

FIG. 3 is a diagram for description of a method of determining an additional point for a wireless relay drone 10. An additional point is assumed herein to be a point separated by a predetermined distance in a perpendicular direction (that is, on a perpendicular bisector 71) from the midpoint of a straight line 70 joining the wireless base station 20 and a wireless relay drone (for example, 10-2) that has transmitted a request signal, in a plan view (in a horizontal plane). In FIG. 3, there are two sides, a K1 side and a K2 side, for a point in the perpendicular direction of the straight line 70. A direction of a failure area transmitted by the request unit 14 is information indicating on which of the K1 side and the K2 side the failure area is present. The additional point is specified to be opposite to the direction of the failure area. The predetermined distance of the additional point from the straight line 70 is a set value that has been determined beforehand but may be modified according to the size of the installed place (building).

In a case where the wireless relay drone 10 was operating in the single unit response mode before the cooperative response mode, because the direction of the failure area has been specified already, the request unit 14 transmits a request signal for addition and the direction of the failure area that has been specified, to the wireless base station 20. In a case where the direction of the failure area has not been specified at the time of this request, the wireless relay drone 10 performs operation to respectively acquire signal intensity values at plural locations and specify the direction in which the communication failure is.

In a case where the failure level is “4”, the wireless relay drone 10 operates in a second cooperative response mode. This failure level 4 corresponds to, for example, a case where the communication status has not improved even if an additional wireless relay drone 10 has been deployed at the failure level 3. In this second cooperative response mode, another additional wireless relay drone 10 is deployed as a result of a drone increase or decrease determination process.

FIG. 2 illustrates a case where a request for addition has been made due to a communication failure (reduction in base station signal intensity value) between the wireless relay drone 10-2 and the wireless base station 20 and two wireless relay drones 10-3 and 10-4 are to be deployed. Another possible case is where a communication failure (reduction in relay signal intensity value) occurs between two wireless relay drones 10 (for example, 10-2 and 10-3) that are relay partners. In that case, an additional wireless relay drone 10 may be deployed between the two wireless relay drones 10-2 and 10-3.

At the failure level, “5”, the wireless relay drone 10 operates in an abnormality detection mode. In the abnormality detection mode, the wireless relay drone 10 outputs an alarm sound by means of the microphone/speaker 19 (see FIG. 1). The drone monitor device 22 outputs an alarm display by means of the display unit 34 (see FIG. 1). The operator 50 is able to respond by performing recovery at the relay point after checking a video on the drone monitor device 22, for example. The alarm sound enables the operator 50 to readily find the wireless relay drone 10.

A failure level is typically expected to increase gradually. However, communication may be suddenly lost for some reason. In this case, an addition request signal from the wireless relay drone 10 may not reach the wireless base station 20. Therefore, the drone monitor device 22 periodically transmits presence confirmation signals to wireless relay drones 10 that are in operation, and in a case where a response signal has not been acquired from any of the wireless relay drones 10 over a predetermined time period, the drone monitor device 22 determines an additional point for a new wireless relay drone 10 and outputs an instruction to the new wireless relay drone 10 for the new wireless relay drone 10 to be placed at the additional point. As a result, even in a case where a request signal from a wireless relay drone 10 does not reach the wireless base station 20, an additional wireless relay drone 10 is able to be deployed.

### Restoration of Communication Failure

In a case where a communication failure has been restored, a request signal to request reduction in drones is transmitted from one of wireless relay drones 10 as a result of a drone increase or decrease determination process.

Upon receipt of the request signal for the reduction, the drone monitor device 22 transmits a return instruction to any wireless relay drone 10 to be eliminated. The wireless relay drone 10 that has received the return instruction returns to a standby location.

### Drone Increase or Decrease Determination Process

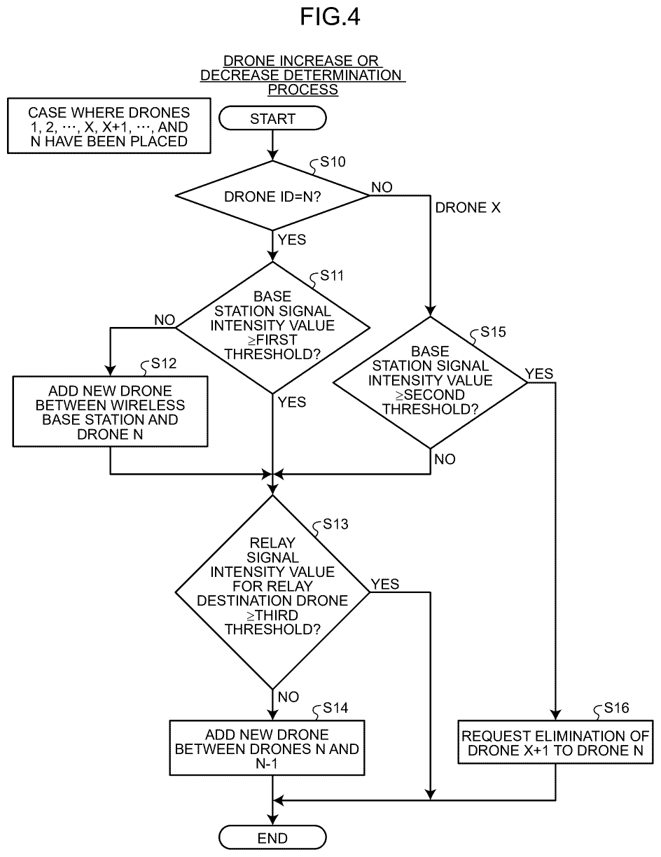

FIG. 4 is a flowchart illustrating a drone increase or decrease determination process. FIG. 5 to FIG. 7 are diagrams along flow charts and illustrating exemplary cases of a request for addition or a request for elimination of a wireless relay drone 10. The drone increase or decrease determination process will be described by reference to FIG. 4 to FIG. 7. The increase or decrease determination process in FIG. 4 is executed by a request unit 14 (see FIG. 1) of a wireless relay drone 10. The number of wireless relay drones 10 that are placed is N and numbers have been respectively assigned as drone IDs to these wireless relay drones 10 in the order, 1, . . . , X, X+1, . . . , and N. It is assumed herein that the wireless relay drone 10 having the drone ID, “1”, is performing wireless communication with a wireless communication terminal, wireless signals are successively relayed between the wireless relay drones 10 having the adjacently numbered drone IDs, and the wireless relay drone 10 having the drone ID, “N”, is performing wireless communication with the wireless base station 20.

At Step S10, a request unit 14 of a wireless relay drone 10 that makes an increase or decrease determination determines whether the wireless relay drone 10 itself is a drone that has been added lastly at a relay point. If the wireless relay drone 10 itself is the drone that has been added lastly, the request unit 14 of the wireless relay drone 10 executes a process of selecting whether to maintain the current status or request addition, and if the wireless relay drone 10 itself is not the drone that has been added lastly, the request unit 14 executes a process of selecting whether to maintain the current status or request return. Specifically, in a case where the drone ID of the wireless relay drone 10 itself is “N” (added lastly, Step S10: Yes), the process is advanced to Step S11, and in a case where the drone ID of the wireless relay drone 10 itself is “other than N” (not added lastly, Step S10: No), the process is advanced to Step S15.

### Drone in Direct Communication With Wireless Base Station

The wireless relay drone 10 having the drone ID, “N”, is in direct communication with the wireless base station 20. In a case where the drone ID is “N”, the request unit 14 determines whether or not a base station signal intensity value is equal to or larger than a first threshold, at Step S11. For example, the first threshold for the signal intensity value is “3” (see Table 1). In a case where the base station signal intensity value is smaller than the first threshold (Step S11: No), the request unit 14 transmits a request signal to request addition of a wireless relay drone 10 that will carry out relay between the wireless relay drone 10 itself (drone ID=N) and the wireless base station 20, at Step S12. After Step S12, the process is advanced to Step S13.

For example, as illustrated in FIG. 5, in a case where a base station signal intensity value at the wireless relay drone 10-2 placed at the point 60-2 is smaller than the first threshold due to a communication failure, the request unit 14 of the wireless relay drone 10-2 transmits a request signal for addition, to the wireless base station 20, at Step S12. As a result, an additional wireless relay drone 10 (see a dotted lined portion) to relay communication between the wireless relay drone 10 and the wireless base station 20 is deployed.

In a case where the base station signal intensity value is equal to or larger than the first threshold at Step S11 (Step S11: Yes), the request unit 14 determines, at Step S13, whether or not a relay signal intensity value for a relay destination (the relay destination for the wireless relay drone 10 having the drone ID of N is assumed to be the wireless relay drone 10 having the drone ID of N−1, the relay destination for the wireless relay drone 10 having the drone ID of X is assumed to be the wireless relay drone 10 having the drone ID of X−1, and the relay destination for the wireless relay drone 10 having the drone ID of 1 is assumed to be the wireless communication terminal) is equal to or larger than a third threshold. The third threshold may have the same value as or a different value from that of the first threshold and in this first embodiment, the third threshold for the signal intensity value is “3”, which is the same as that of the first threshold (see Table 1). In a case where the relay signal intensity value is smaller than the third threshold (Step S13: No), the request unit 14 transmits a request signal to request for addition of a wireless relay drone 10 that will perform relay between the wireless relay drone 10 (N−1) at the relay destination and its own drone (N) at Step S14. What is supposed here is a case where a communication failure has occurred between two wireless relay drones 10 that are relay partners.

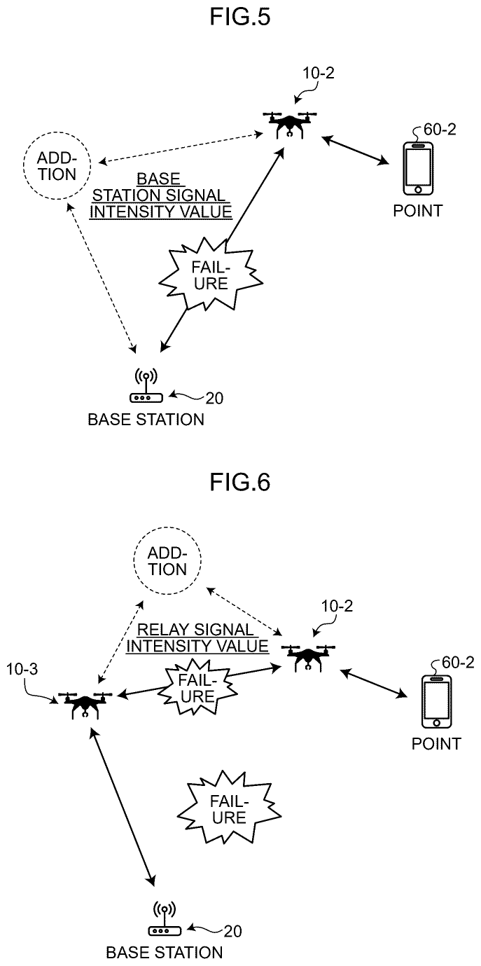

That is, as illustrated in FIG. 6, a situation where the wireless relay drone 10-3 has been added for the wireless relay drone 10-2 is assumed. In a case where a relay signal intensity value between the wireless relay drone 10-2 and the wireless relay drone 10-3 is smaller than the third threshold, the request unit 14 of the wireless relay drone 10-3 transmits a request signal for addition, to the wireless base station 20. As a result, an additional wireless relay drone 10 is deployed at an additional point (see a dotted lined portion) for relay between the wireless relay drone 10-2 and the wireless relay drone 10-3.

In a case where the relay signal intensity value for the relay destination (drone ID=N−1) is equal to or larger than the third threshold at Step S13 in FIG. 4 (Step S13: Yes), the request unit 14 ends the process to maintain the current status.

### Drones Other Than Drone in Direct Communication With Wireless Base Station

The wireless relay drones 10 having the drone IDs other than “N” are not in direct communication with the wireless base station 20. In a case where the drone ID is other than “N” (drone ID=X) at Step S10 (Step S10: No), the request unit 14 determines whether or not a base station signal intensity value is equal to or larger than a second threshold, at Step S15. The second threshold has a value equal to or larger than that of the first threshold, and in this first embodiment, the second threshold for the signal intensity value is “3”, which is the same as the first threshold (see Table 1).

In a case where the base station signal intensity value is equal to or larger than the second threshold (Step S15: Yes), the request unit 14 transmits a request signal to request reduction in drones, at Step S16. That is, in a case where the base station signal intensity value is equal to or larger than the second threshold (“3”) in a state where there are more than one other wireless relay drone 10, the request unit 14 transmits a request signal to request for elimination of all of the wireless relay drones 10 that perform relay between its own drone and the wireless base station 20. This corresponds to a case where the communication failure has been solved and relay by additional drones is no longer needed.

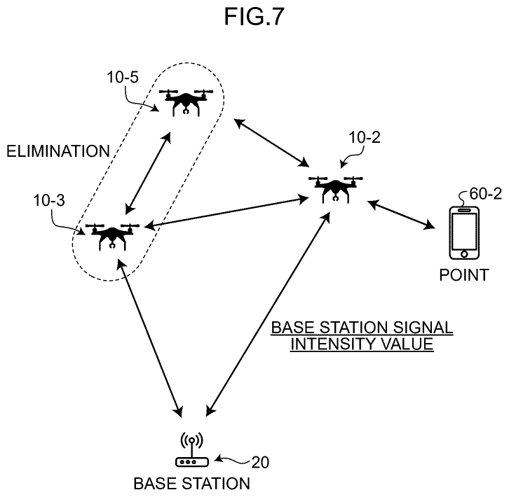

For example, as illustrated in FIG. 7, a situation where the wireless relay drone 10-3 and a wireless relay drone 10-5 have been added for the wireless relay drone 10-2 is supposed. In a case where the base station signal intensity value at the wireless relay drone 10-2 is equal to or larger than the second threshold, the request unit 14 of the wireless relay drone 10-2 transmits a request signal for reduction to the wireless base station 20. As a result, the wireless relay drone 10-3 and the wireless relay drone 10-5 return to their standby locations.

In a case where the base station signal intensity value is less than the second threshold at Step S15 in FIG. 4 (Step S15: No), the request unit 14 proceeds to Step S13. This corresponds to a case where the communication failure between its own drone and the wireless base station 20 is still ongoing and relay is still needed. Processing at Step S13 and Step S14 for the wireless relay drone 10 having the drone ID of X is similar to the processing for the wireless relay drone 10 having the drone ID of N, but the drone at its relay destination is the wireless relay drone 10 having the drone ID of X−1.

### Example of Relay by Wireless Relay Drone

An example of relay by wireless relay drones will be described next by reference to FIG. 2.

### Case Without Failure

A case without a failure will be described first. For example, a relay point is set up at a point 60-1. The drone monitor device 22 is operated by the operator 50 and the point 60-1 is specified. The wireless relay drone 10-1 flies to the specified location (point 60-1) and measures a base station signal intensity value for the wireless base station 20. The wireless relay drone 10-1 transmits various measurement results including the base station signal intensity value and positional information, to the wireless base station 20.

In a case according to this embodiment, the drone monitor device 22 (determination unit 33) determines the failure level to be “0” because the signal intensity value at the point 60-1 is “4” (see Table 1). The drone monitor device 22 transmits a response instruction corresponding to the failure level determination result, to the wireless relay drone 10-1. The wireless relay drone 10-1 operates in the standby mode (see Table 2), stays in the air or lands at the point 60-1, and continues the wireless relay.

### Case With Failure

A case with a failure will be described next. For example, a relay point is set up at a point 60-2. The operator 50 operates the drone monitor device 22 and specifies the point 60-2 as a location. The wireless relay drone 10-2 flies to the specified location (point 60-2) and measures a base station signal intensity value for the wireless base station 20. It is supposed herein that a noise source is present at a point 60-3 between the wireless relay drone 10-2 and the wireless base station 20 and the base station signal intensity value is “2” (see Table 1).

The wireless relay drone 10-2 operates in the cooperative response mode (see Table 2). As a result of a drone increase or decrease determination process (see FIG. 4), the wireless relay drone 10-2 transmits a request signal for addition of a drone, to the wireless base station 20. As a result, the wireless relay drone 10-3 is added.

It is now assumed that a noise source has been generated at a point 60-4 even though the wireless relay drone 10-3 has been added. In this case, as a result of a drone increase or decrease determination process (see FIG. 4), the wireless relay drone 10-3 transmits a request signal for addition of a drone, to the wireless base station 20. As a result, the wireless relay drone 10-4 is added.

### Flow of Operation in Communication System

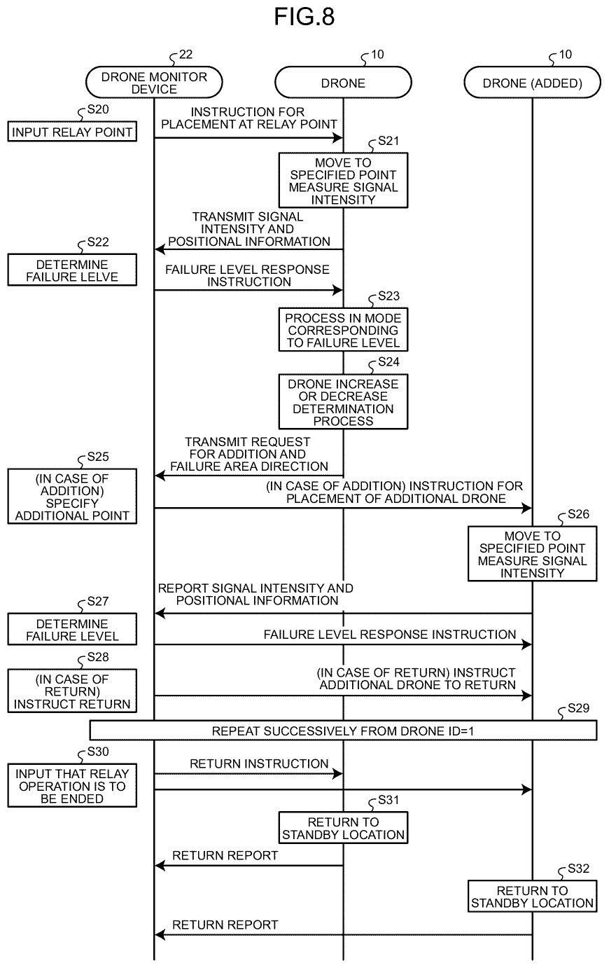

FIG. 8 is a sequence diagram illustrating a flow of sequential operation in the communication system CS. The operation in the communication system CS according to the first embodiment will be described by reference to FIG. 8.

Firstly, the drone monitor device 22 receives input of a relay point of a first wireless relay drone 10 from the operator 50 (see FIG. 2) (Step S20). The drone monitor device 22 outputs an instruction for placement at the relay point to the first wireless relay drone 10.

The first wireless relay drone 10 flies to the relay point specified, measures various data including a signal intensity value, and transmits the various data to the wireless base station 20 (Step S21).

The wireless base station 20 respectively stores the data received into the sensor data storage unit 37, the video data storage unit 38, and the position storage unit 40, determines a failure level by means of the determination unit 33 (see Table 1), and transmits a response instruction corresponding to the failure level, to the first wireless relay drone 10 (Step S22).

The first wireless relay drone 10 determines a drone mode from the failure level (see Table 2) and executes a process in that drone mode (Step S23). In this process, the first wireless relay drone 10 (request unit 14) performs a drone increase or decrease determination process in FIG. 4 (Step S24). The first wireless relay drone 10 (request unit 14) transmits a request for addition or elimination as a result of the drone increase or decrease determination process and a failure area direction, for example, to the wireless base station 20.

### Case Where Wireless Relay Drone is Added

In a case where the wireless base station 20 has received a request signal for addition, the wireless base station 20 specifies an additional point to an additional wireless relay drone 10 (added) (Step S25). The additional wireless relay drone 10 (added), to which the additional point has been specified, flies to the additional point specified, and transmits various data including a signal intensity value, to the wireless base station 20 (Step S26). The wireless base station 20 determines a failure level (see Table 1) and transmits the failure level determined, to the additional wireless relay drone 10 (Step S27). Thereafter, the additional wireless relay drone 10 (added) executes processing similar to that of Step S23 and Step S24 according to a failure level response instruction, and if addition of another wireless relay drone 10 is determined to be needed, Step S26 and Step S27 are executed and these steps are repeated until the wireless communication terminal and the wireless base station 20 are able to communicate with each other without any failure.

### Case Where Wireless Relay Drone is Eliminated

Although illustration thereof is omitted, wireless relay drones 10 periodically measure base station signal intensity values of signals received from the wireless base station 20, and in a case where a wireless relay drone 10 determines that a base station signal intensity value has become equal to or larger than the second threshold (Step S15: Yes), the wireless relay drone 10 transmits a request signal to request reduction in drones, to the wireless base station 20 (Step S16). In a case where the wireless base station 20 has received the request signal for reduction, the wireless base station 20 transmits a return instruction to the wireless relay drone 10 (added) that the wireless base station 20 has received the request from (Step S28). In a case where any other additional wireless relay drone 10 (a wireless relay drone 10 having a drone ID of a number larger than that of the drone ID of the wireless relay drone 10 instructed to return) has been deployed between the wireless relay drone 10 instructed to return and the wireless base station 20, the wireless base station 20 transmits a return instruction to all of such additional drones.

The communication system CS repeats each of the above described steps for each wireless relay drone 10 in operation, until relay operation is ended (Step S29). Each wireless relay drone 10 periodically transmits various data, such as signal intensity values, to the wireless base station 20. In a case where any signal intensity value has been updated, the wireless base station 20 redetermines a failure level and transmits the failure level redetermined, to the relevant wireless relay drone 10. The wireless relay drone 10 that has received the failure level performs a process according to the failure level. Addition and elimination of wireless relay drones 10 are thereby repeated as appropriate, and the communication path between the wireless communication terminal and the wireless base station 20 is maintained.

### End of Relay Operation

The wireless base station 20 detects operation input to the drone monitor device 22 by the operator 50 who has determined that the relay operation in the communication system CS is to be ended. On the basis of the detected operation by the operator 50, the wireless base station 20 transmits a return instruction to all of the wireless relay drones 10 (Step S30).

Each of the wireless relay drones 10 returns to a predetermined standby location upon receipt of the return instruction (Step S31 and Step S32). When each of the wireless relay drones 10 has landed at its standby location, the wireless relay drone 10 transmits a return report to the wireless base station 20.

### Effects of First Embodiment

A wireless relay drone 10 (unmanned wireless relay mobile unit) according to the first embodiment includes: a communication unit 12 that relays a wireless signal; a signal intensity measurement unit 13 that measures a signal intensity value of a wireless signal received by the communication unit 12; and a request unit 14 that communicates, by means of the communication unit 12, a request signal to request addition or elimination of a wireless relay drone 10, to the wireless base station 20 on the basis of the signal intensity value. The signal intensity measurement unit 13 measures a base station signal intensity value of a signal received by the communication unit 12 from the wireless base station 20 and a relay signal intensity value of a signal received from another wireless relay drone 10 in operation. In a case where the wireless relay drone 10 is in direct communication with the wireless base station 20, the request unit 14 transmits a request signal to add a wireless relay drone 10 when the base station signal intensity value is smaller than the first threshold or the relay signal intensity value for the relay destination is smaller than the third threshold. In a case where the wireless relay drone 10 is not in direct communication with the wireless base station 20, the request unit 14 transmits a request signal to request elimination of the other wireless relay drone 10 in operation when the base station signal intensity value is equal to or larger than the second threshold, and transmits a request signal to request addition of a wireless relay drone 10 when the base station signal intensity value is smaller than the second threshold and the relay signal intensity value for the relay destination is smaller than the third threshold.

Therefore, in a case where a base station signal intensity value or a relay signal intensity value for a relay destination has decreased at a relay point, deployment of an additional wireless relay drone 10 enables stable wireless communication. Furthermore, in a case where the base station signal intensity value has increased at the relay point, a request signal for reduction enables reduction in the number of wireless relay drones 10 in operation. As a result, in a range where stable wireless communication is maintainable, the number of wireless relay drones 10 in operation is able to adjusted to an appropriate number according to a usage status.

FIG. 2 illustrates, for convenience, an example where a communication area is constructed in an indoor space that is rectangular in a plan view but the indoor space may have a complex shape bent to be L-shaped or U-shaped, or the indoor space may be partitioned by various obstacles, for example. In that case, many relay devices are usually needed to construct a stable communication area. However, in the first embodiment, even in a case where the environment where a communication area is to be constructed has a complex structure, deploying and eliminating wireless relay drones 10 enable adaptive construction of a communication area enabling flexible response to any failure area and operation with the minimum necessary number of wireless relay drones 10 in operation.

The signal intensity measurement unit 13 in the wireless relay drone 10 (unmanned wireless relay mobile unit) according to the first embodiment finds a base station signal intensity value by measuring signal intensities of presence confirmation signals periodically received from the wireless base station 20, periodically transmits signals to another wireless relay drone 10 at a relay destination and finds a relay signal intensity value by measuring a response signal therefrom. Base station signal intensity values and relay signal intensity values are thereby able to be periodically acquired and updated. As a result, even in a case where a sudden communication failure occurs or is restored, the change in the communication failure status is able to be adequately addressed.

In a case where a base station signal intensity value is larger than the second threshold in a state where there are more than one other wireless relay drone 10, the request unit 14 of the wireless relay drone 10 (unmanned wireless relay mobile unit) according to the first embodiment transmits a request signal to request elimination of all of the other wireless relay drones 10 that perform relay between its own wireless relay drone 10 and the wireless base station 20. In a case where the communication failure is restored or relieved, all of the wireless relay drones 10 that have been deployed to perform the relay between its own wireless relay drone 10 and the wireless base station 20 are eliminated, and the number of wireless relay drones 10 in operation that are in excess is thus able to be effectively reduced according to the communication status.

In a case where a base station signal intensity value is smaller than the first threshold, the request unit 14 in the wireless relay drone 10 (unmanned wireless relay mobile unit) according to the first embodiment transmits a request signal to request addition of a wireless relay drone 10 that will perform relay between its own wireless relay drone 10 and the wireless base station 20, and in a case where a relay signal intensity value for a relay destination is smaller than the third threshold, the request unit 14 transmits a request signal to request addition of another wireless relay drone 10 that will perform relay between the added wireless relay drone 10 at the relay destination and its own wireless relay drone 10. An additional wireless relay drone 10 is thereby able to be deployed according to a status of the communication failure, not only between its own wireless relay drone 10 and the wireless base station 20, but also between its own wireless relay drone 10 and the added wireless relay drone 10 at the relay destination. Therefore, even upon a communication failure, a stable wireless communication area is able to be constructed and maintained.

The signal intensity measurement unit 13 of the wireless relay drone 10 (unmanned wireless relay mobile unit) according to the first embodiment respectively acquires signal intensity values at plural locations in a predetermined range including its relay point for wireless signals, and in a case where the request unit 14 transmits a request signal to request addition of a wireless relay drone 10, the request unit 14 transmits a direction of a failure area where a communication failure has occurred, to the wireless base station 20, on the basis of the plural signal intensity values and positional information that have been acquired at the plural locations. An additional point for the wireless relay drone 10 to be added is thereby able to be determined so as to avoid the direction of the failure area. As a result, even in a case where a communication failure has occurred, wireless communication is able to be maintained efficiently with a smaller number of wireless relay drones 10 in operation.

The drone main unit (mobile main unit) 11 of the wireless relay drone 10 (unmanned wireless relay mobile unit) according to the first embodiment is an unmanned aerial vehicle. The wireless relay drone 10 is thus able to be operated in the air. In an indoor environment, such as a factory, various obstacles, such as machinery and installed objects, are often present on the ground. Therefore, complex control is needed to move ground-moving unmanned mobile units to relay points, and relayed radio waves tend to be blocked by the machinery and installed objects. In contrast, the wireless relay drones 10 are not easily affected by such obstacles both when the wireless relay drones 10 are moving and relayed radio waves are not easily affected by such obstacles either, and a communication area is thus able to be constructed sufficiently with a smaller number of wireless relay drones 10 in operation.

The wireless base station 20 according to the first embodiment communicates with a wireless relay drone (unmanned wireless relay mobile unit) 10 including: a communication unit 12 that relays a wireless signal; a signal intensity measurement unit 13 that measures a signal intensity value of a wireless signal received by the communication unit 12; and a request unit 14 that transmits a request signal to request addition or elimination of a wireless relay drone 10, to the wireless baes station 20. The wireless base station 20 includes: the wireless router (base station communication unit) 21 that transmits and receives wireless signals; and the drone monitor device (instruction unit) 22 that outputs an instruction to a new wireless relay drone 10 for the new wireless relay drone 10 to be placed at an additional point. The drone monitor device 22 periodically transmits presence confirmation signals to wireless relay drones 10 in operation, and in a case where a response signal has not been acquired from any of the wireless relay drones 10 over a predetermined time period, the drone monitor device 22 determines an additional point for a new wireless relay drone 10, and outputs an instruction to the new wireless relay drone 10 for the new wireless relay drone 10 to be placed at the additional point. Even in a case where communication is disabled before a request signal for addition is acquired from a wireless relay drone 10 due to a sudden communication failure or breakdown, for example, the wireless base station 20 is able to voluntarily deploy an additional wireless relay drone 10 independently of a request signal. As a result, without being affected by a reduction in the number of wireless relay drones 10 in operation, flexible operation of wireless relay drones 10 is enabled, the flexible operation allowing a communication area to be maintained in response to a sudden communication failure or breakdown, for example.

### Second Embodiment

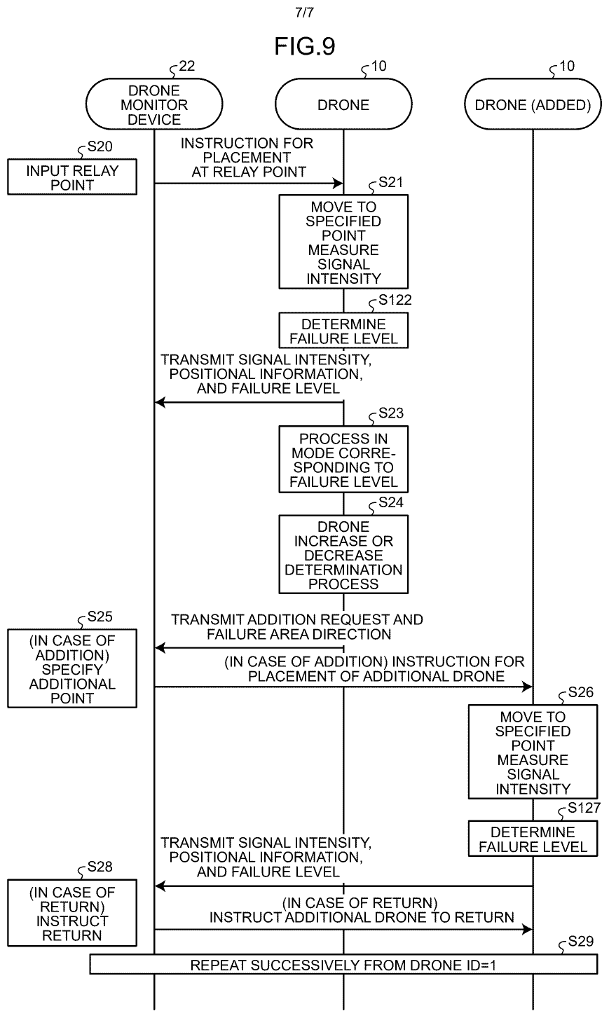

A second embodiment will be described by reference to FIG. 9. FIG. 9 is a sequence diagram illustrating a flow of sequential operation in a communication system CS (wireless relay drones 10 and a wireless base station 20) according to the second embodiment. In a case where any component of the wireless relay drones 10 and the wireless base station 20 is similar to that of the first embodiment described above, the same or corresponding reference sign will be assigned to the component and detailed description thereof will be omitted, hereinafter.

An example where the wireless base station 20 determines a failure level and transmits a response instruction in a mode corresponding to the determined failure level to a wireless relay drone 10 has been described above with respect to the first embodiment, but an example where a wireless relay drone 10 determines a failure level and determines a mode corresponding to the determined failure level on its own will be described with respect to the second embodiment.

In the second embodiment, a wireless relay drone 10 flies to a relay point that has been specified and acquires various data including a signal intensity value (Step S21). After the acquisition of the data, the wireless relay drone 10 (a request unit 14) determines a failure level according to Table 1, on the basis of the signal intensity value and positional information (Step S122). The wireless relay drone 10 transmits the failure level determined and the signal intensity value, to the wireless base station 20.

The wireless relay drone 10 executes a process in a drone mode (see Table 2) corresponding to a result of the determination of the failure level (Step S23). In this process, the wireless relay drone 10 (request unit 14) performs a drone increase or decrease determination process in FIG. 4 (Step S24). The wireless relay drone 10 (request unit 14) transmits a request for addition or a request for elimination, and a failure area direction, which have been determined, for example, to the wireless base station 20.

An additional wireless relay drone (added) 10 in a case where a request signal for addition has been transmitted flies to an additional point specified and acquires various data including a signal intensity value (Step S26). After the acquisition of the data, the additional wireless relay drone (added) 10 (request unit 14) determines a failure level according to Table 1 on the basis of the signal intensity value and positional information (Step S127) and transmits the failure level determined and the signal intensity value, to the wireless base station 20.

Other operation in the second embodiment is similar to that of the first embodiment illustrated in FIG. 8. In the second embodiment, the wireless base station 20 does not perform determination of a failure level and a determination unit 33 may thus be not provided in a drone monitor device 22 thereof.

Effects of the second embodiment are similar to those of the first embodiment.

An example where a failure level is determined has been described above with respect to the first and second embodiments, but the first and second embodiments are not to be limited to this configuration. For example, a wireless relay drone 10 is capable of transmitting a request signal for addition or elimination on the basis of a signal intensity value that the wireless relay drone 10 itself has acquired and thus does not necessarily perform determination of a failure level.

Furthermore, an example where the first threshold for determining transmission of a request for addition and the second threshold for determining transmission of a request for elimination have the same value (“3”) has been described above with respect to the first and second embodiments, but the second threshold may be larger than the first threshold.

Furthermore, an example where a request unit 14 transmits the direction of a failure area to the wireless base station 20 on the basis of plural signal intensity values and positional information acquired at plural locations has been described above with respect to the first and second embodiments, but the direction of the failure area may be not transmitted. In this case, the additional point for the wireless relay drone 10 to be deployed according to the request signal for addition may be determined to be on a preset one of the K1 side and the K2 side in FIG. 3. Even in a case where the additional point is on the side where the failure area is, deployment of yet another additional wireless relay drone 10 enables wireless relay, for example.

Furthermore, an example where the drone main units (mobile main units) 11 are unmanned aerial vehicles has been described above with respect to the first and second embodiments, but the mobile main units may be ground-moving unmanned mobile units. That is, unmanned wireless relay mobile units may be unmanned mobile units of kinds other than unmanned aerial vehicles without being limited to wireless relay drones 10.

Furthermore, an example where the wireless relay drones 10 and the wireless base station 20 construct a communication area indoors has been described above with respect to the first and second embodiments, but a communication area may be constructed outdoors.

Furthermore, signal intensity values are categorized into five levels, “none and 1 to 4”, in the first and second embodiments described above, but signal intensity values may be categorized into two, three, four, six, or more levels. Distances from the wireless base station 20 on the basis of positional information are categorized into three levels, “near, medium, and far”, in the first and second embodiments, but distances from the wireless base station 20 may be categorized into two, four, or more levels.

Each component of the wireless relay drones 10 (unmanned wireless relay mobile units) and wireless base station 20 has been functionally and/or conceptually illustrated in the drawings and is not necessarily configured physically as illustrated in the drawings. That is, the specific form of each device is not limited to the one illustrated in the drawings, and all or part of each device may be functionally or physically separated or integrated in any units according to, for example, the processing load on the device and the use situation of the device.

An embodiment of the present invention has an effect of enabling the number of unmanned wireless relay mobile units in operation to be adjusted to an appropriate number according to a usage status.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An unmanned wireless relay mobile unit, comprising:
a communication unit that relays a wireless signal;
a signal intensity measurement unit that measures a signal intensity value of a wireless signal received by the communication unit; and
a request unit that communicates, by means of the communication unit, a request signal to request addition or elimination of an unmanned wireless relay mobile unit, to a wireless base station, on the basis of the signal intensity value, wherein
the signal intensity measurement unit measures a base station signal intensity value of a signal received by the communication unit from the wireless base station and a relay signal intensity value of a signal received from another unmanned wireless relay mobile unit in operation, and
in a case where the unmanned wireless relay mobile unit is in direct communication with the wireless base station, the request unit transmits the request signal to request addition of another unmanned wireless relay mobile unit when the base station signal intensity value is smaller than a first threshold or when the relay signal intensity value for a relay destination is smaller than a third threshold.

2. The unmanned wireless relay mobile unit according to claim 1, wherein in a case where the unmanned wireless relay mobile unit is not in direct communication with the wireless base station, the request unit transmits the request signal to request elimination of the other unmanned wireless relay mobile unit in operation when the base station signal intensity value is equal to or larger than a second threshold and transmits the request signal to request addition of another unmanned wireless relay mobile unit when the base station signal intensity value is smaller than the second threshold and the relay signal intensity value for the relay destination is smaller than the third threshold.

3. The unmanned wireless relay mobile unit according to claim 2, wherein the signal intensity measurement unit
finds the base station signal intensity value by measuring signal intensities of presence confirmation signals periodically received from the wireless base station, and
periodically transmits signals to the other unmanned wireless relay mobile unit at the relay destination and find the relay signal intensity value by measuring response signals received therefrom.

4. The unmanned wireless relay mobile unit according to claim 2, wherein in a case where the base station signal intensity value is equal to or larger than the second threshold in a state where there are more than one other unmanned wireless relay mobile unit, the request unit transmits the request signal to request elimination of all of the other unmanned wireless relay mobile units that performs relay between the wireless relay mobile unit and the wireless base station.

5. The unmanned wireless relay mobile unit according to claim 2, wherein the request unit
transmits the request signal to request addition of an unmanned wireless relay mobile unit that performs relay between the unmanned wireless relay mobile unit and the wireless base station in a case where the base station signal intensity value is smaller than the first threshold, and
transmits the request signal to request addition of an unmanned wireless relay mobile unit that performs relay between the other unmanned wireless relay mobile unit at the relay destination and the unmanned wireless relay mobile unit in a case where the relay signal intensity value for the relay destination is smaller than the third threshold.

6. A wireless base station that communicates with an unmanned wireless relay mobile unit that comprises: a communication unit that relays a wireless signal; a signal intensity measurement unit that measures a signal intensity value of a wireless signal received by the communication unit; and a request unit that transmits a request signal to request addition or elimination of an unmanned wireless relay mobile unit to the wireless base station on the basis of the signal intensity value, the wireless base station comprising:
a base station communication unit that transmits and receives wireless signals; and
an instruction unit that determines, in a case where the base station communication unit has received the request signal to request addition of a new unmanned wireless relay mobile unit from the unmanned wireless relay mobile unit, an additional point for the new unmanned wireless relay mobile unit and outputs an instruction to the new unmanned wireless relay mobile unit for the new unmanned wireless relay mobile unit to be placed at the additional point, wherein
the instruction unit periodically transmits presence confirmation signals to unmanned wireless relay mobile units in operation and in a case where the instruction unit has not acquired a response signal from any of the unmanned wireless relay mobile units in operation over a predetermined time period, the instruction unit determines an additional point for a new unmanned wireless relay mobile unit and outputs an instruction to this new unmanned wireless relay mobile unit for the new unmanned wireless relay mobile unit to be placed at the additional point.
